(19) United States
(12) Patent Application Publication
(10) Pub. No.: US 2013/0108992 A1
(43) Pub. Date: May 2, 2013

(54) MOTION SIMULATOR AND CORRESPONDING METHOD

(71) Applicants: Heinrich H. Buelthoff, Tuebingen (DE); Harald Teufel, Reutlingen (DE); Michael Kerger, Nehren (DE)

(72) Inventors: Heinrich H. Buelthoff, Tuebingen (DE); Harald Teufel, Reutlingen (DE); Michael Kerger, Nehren (DE)

(73) Assignee: Max-Planck-Gesellschaft zur Foerderung der Wissenschaften, e.V., Muenchen (DE)

(21) Appl. No.: 13/698,649

(22) PCT Filed: May 21, 2010
(86) PCT No.: PCT/EP2010/003132

§ 371 Date: Jan. 18, 2013

(51) Int. Cl. G09B 9/12

(52) U.S. Cl. CPC G09B 9/12
USPC 434/33

(57) ABSTRACT

The invention relates to a motion simulator for simulating a motion of a vehicle, particularly an aircraft, comprising: a multi-axis serial robot (1) comprising a rotatable base axis (2), and a seat (17) for an operator, wherein the seat (17) is attached to the multi-axis serial robot (1), so that the seat (17) can be moved in space by the multi-axis serial robot (1) for simulation of a real movement, wherein the motion simulator is adapted to simulate a long-lasting acceleration or deceleration by generating a centrifugal force acting on the operator. Further, the invention relates to a corresponding method.

### FIELD OF THE INVENTION

The invention relates to a motion simulator for simulating a motion of a vehicle, particularly an aircraft like a helicopter. Further, the invention relates to a corresponding method for simulating a motion of a vehicle.

### BACKGROUND OF THE INVENTION

The use of a multi-axis serial robot for simulating a motion of a vehicle is disclosed, for example in Nusseck/Teufel/Nieuwenhuizen/Bulthoff: “Learning System Dynamics: Transfer of Training in a Helicopter Hover Simulator”, AIAA Modeling and Simulation Technologies Conference and Exhibit, 18-21 Aug. 2008, Honolulu, Hi. Further, it is well-known in the state of the art to use a so-called Stewart platform for simulating a motion of a vehicle. However, both the conventional Stewart platform and the multi-axis serial robot suffer from the fundamental drawback that the workspace of these manipulators is limited, so that it is difficult or almost impossible to simulate long-lasting accelerations or decelerations.

### SUMMARY OF THE INVENTION

Therefore, it is an object of the invention to improve the simulation of long-lasting accelerations or decelerations.

This object is achieved by a novel motion simulator and a corresponding method according to the independent claims.

The invention is based on the basic idea to simulate long-lasting accelerations or decelerations by generating a centrifugal force acting on the operator, wherein the centrifugal forces are generated by rotating the multi-axis serial robot around a preferably vertical axis of rotation, e.g. around the robot base.

The motion simulator according to the invention comprises a multi-axis serial robot comprising a rotatable base axis. Such a multi-axis serial robot is per se well known and commercially available, e.g. from German company KUKA Roboter GmbH.

Further, the motion simulator according to the invention comprises a seat for an operator, wherein the seat is attached to the multi-axis serial robot, so that the seat can be moved in space by the multi-axis serial robot for simulation of a real movement of a vehicle. Insofar, the motion simulator according to the invention corresponds to the conventional motion simulator as disclosed, for example, in the afore-mentioned publication titled “Learning System Dynamics: Transfer of Training in a Helicopter Hover Simulator”.

However, the motion simulator according to the invention distinguishes from the conventional motion simulator in that it is adapted to simulate a long-lasting acceleration or deceleration by generating a centrifugal force acting on the operator in the seat of the motion simulator. For this purpose, the rotatable base axis of the multi-axis serial robot is preferably indefinitely rotatable, so that long-lasting centrifugal forces can be generated without any time restrictions.

Therefore, the rotatable base axis of the motion simulator according to the invention is distinguished from the afore-mentioned conventional motion simulator in that it comprises a slip ring making an electrical connection between the rotatable parts of the rotatable axis, wherein the slip ring allows an unlimited rotation of the rotatable base axis which is important for generating long-lasting centrifugal forces. Further, the rotatable base axis preferably comprises a rotary feed-through making a pneumatic or hydraulic connection between the rotatable parts of the rotatable base axis, wherein the rotary feed-through allows an unlimited rotation of the rotatable base axis.

In a preferred embodiment of the invention, the motion simulator additionally comprises a linear axis, wherein the multi-axis serial robot is moveable along the linear axes, so that the work space of the multi-axis serial robot is expanded thereby making the simulation more realistic. In other words, the entire multi-axis serial robot can be moved along the linear axis in order to simulate long-lasting accelerations or decelerations acting on the operator. The linear axis preferably allows a linear movement of the multi-axis serial robot of more than 2 m, 4 m, 6 m, 8 m or even more than 10 m.

It should further be noted that the linear axis can be curved or even ring-shaped which allows an endless movement of the multi-axis serial robot on the linear axis. Moreover, it is possible to arrange more than one linear axis thereby creating a corresponding number of additional degrees of freedom of movement.

In the preferred embodiment of the invention, the seat is attached to a tool center point (TCP) of the multi-axis serial robot by an additional seat axis providing an additional degree of freedom of movement, wherein the seat axis allows a movement of the seat relative to the tool center point of the multi-axis serial robot. Preferably, the seat axis is attached to the mounting flange of a hand wrist of the multi-axis serial robot.

The seat axis preferably allows at least a rotation of the seat in the sagittal plane of the operator in the seat. In other words, the seat axis allows a forwards and rearwards directed tilt movement of the operator in the seat. It should further be noted that the seat axis preferably allows a rotary movement of at least 90° in the sagittal plane of the operator in the seat.

Further, it is possible that the seat axis allows at least a rotation of the seat in the transversal plane and/or in the frontal plane of the operator in the seat. The rotation of the seat can be realized by a corresponding movement of the seat axis alone. However, the rotation of the seat is preferably realized by a combination of movements of the seat axis and other axes of the multi-axis serial robot.

In the preferred embodiment of the invention, the seat can be aligned such that the centrifugal force caused by the rotation of the multi-axis serial robot around the base axis is cranially directed with regard to the operator. In other words, the centrifugal force is aligned vertically upwards with regard to the operator in the seat of the motion simulator.

Further, the seat can be preferably aligned such that the centrifugal force caused by the rotation of the multi-axis serial robot around the base axis is caudally directed with regard to the operator in the seat. In other words, the seat can be aligned such that the centrifugal force is aligned vertically downwards relative to the operator in the seat.

Alternatively, the seat can be aligned such that the centrifugal force caused by the rotation of the multi-axis serial robot around the base axis is ventrally directed with regard to the operator. In other words, the seat can be aligned in such a way that the operator in the seat perceives a forwards directed centrifugal force.

Alternatively, the seat can be aligned in such a way that the centrifugal force is aligned dorsally or laterally.

In the preferred embodiment of the invention, the seat axis comprises a curved guide rail and a carriage which is moveable along the guide rail, wherein the carriage is preferably attached to the tool center point (e.g. the mounting flange of the hand wrist) of the multi-axis serial robot, while the guide rail is attached to the seat, so that the seat is moveable relative to the tool center point of the multi-axis serial robot. In other words, the guide rail along with the seat can be moved along the carriage thereby rotating the seat according to the curvature of the guide rail. Therefore, the guide rail is preferably substantially L-shaped, C-shaped, O-shaped, circular or elliptical. However, it should be noted that it is alternatively possible that the carriage is attached to the seat for the operator, while the curved guide rail is attached to the tool center point of the multi-axis serial robot. The afore-mentioned design of the seat axis allows a rotation of the operator in the seat around a laterally aligned axis of rotation. In other words, the seat axis allows a tilt movement forwards and backwards.

It should further be noted that the seat is preferably arranged in a closed cabin so that the operator in the seat does not perceive any tilt of the cabin relative to the real world but merely feels corresponding forces.

Further, the cabin preferably comprises at least one visual display, particularly a projection display and/or a stereoscopic display. Moreover, it should be noted that the cabin preferably resembles the cabin or cockpit of the vehicle to be simulated, e.g. a real helicopter.

In the preferred embodiment of the invention, the motion simulator comprises a hardware limit stop limiting the motion space of the multi-axis serial robot to avoid a collision. Further, the motion simulator preferably comprises a software limit stop limiting the motion space of the multi-axis serial robot to avoid a collision. Further, there is preferably a multi-step safety arrangement comprising software end stops in an operating program of the motion simulator, software end stops in a robot controller and also hardware end stops in the multi-axis serial robot.

Finally, it should be noted that the invention is not restricted to a motion simulator as described above but also encompasses a corresponding method for simulating a motion of a vehicle.

The invention and its particular features and advantages will become more apparent from the following detailed description considered with reference to the accompanying drawings.

### BRIEF DESCRIPTION OF THE DRAWINGS

FIGS. 1-4 illustrate a preferred embodiment of a motion simulator according to the invention in different positions.

FIGS. 5 and 6 illustrate different positions of a cabin of the motion simulator as shown in FIGS. 1-4.

FIG. 7 shows a side view of an alternative embodiment of a motion simulator according to the invention additionally comprising a linear axis.

FIG. 8 shows a scheme illustrating the anatomical terms of location as used in the description.

### DETAILED DESCRIPTION OF THE DRAWINGS

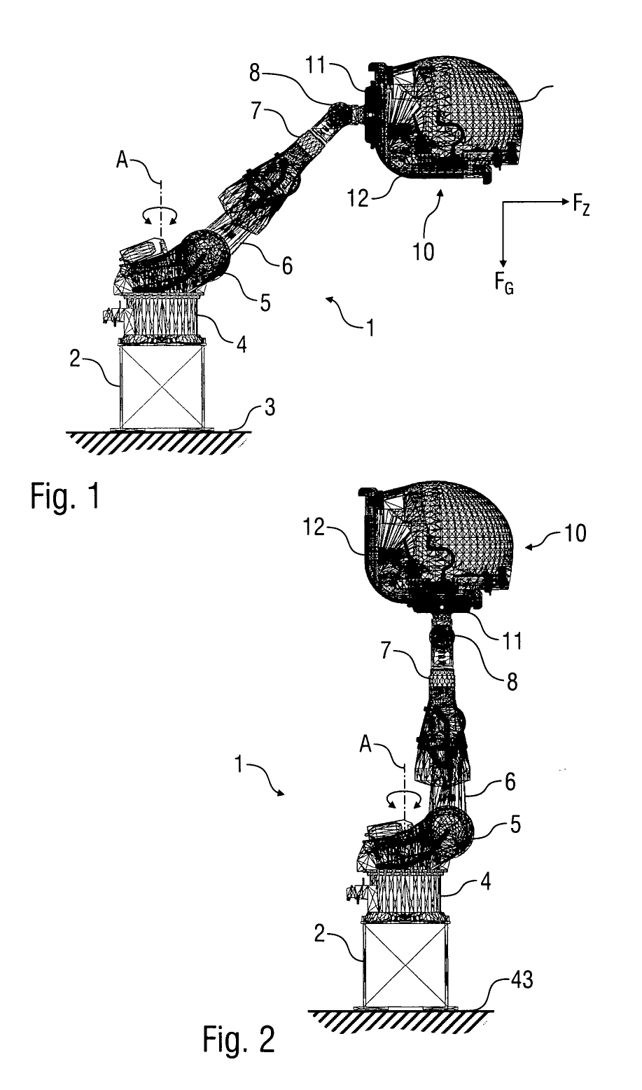

FIGS. 1-6 illustrate a first embodiment of a motion simulator according to the invention, wherein the motion simulator is adapted for simulating a motion of a helicopter. However, the motion simulator could alternatively be adapted for simulation of a motion of any other type of vehicle, e.g. airplanes.

The motion simulator comprises a multi-axis serial robot 1 which is per se known in the state of the art and commercially available, e.g. from German company KUKA Roboter GmbH.

The multi-axis serial robot 1 comprises a robot base 2 which is fixed to a foundation 3.

Further, the multi-axis serial robot 1 comprises a rotatable base axis 4 carrying a rotatable robot link 5, wherein the robot link 5 is rotatable relative to the robot base 2 around a vertical axis of rotation A.

Moreover, the multi-axis serial robot 1 comprises two pivotable robot arms 6, 7 and a conventional hand wrist 8, wherein the hand wrist 8 provides three degrees of freedom of movement, so that the multi-axis serial robot 1 comprises a total of six degrees of freedom of movement.

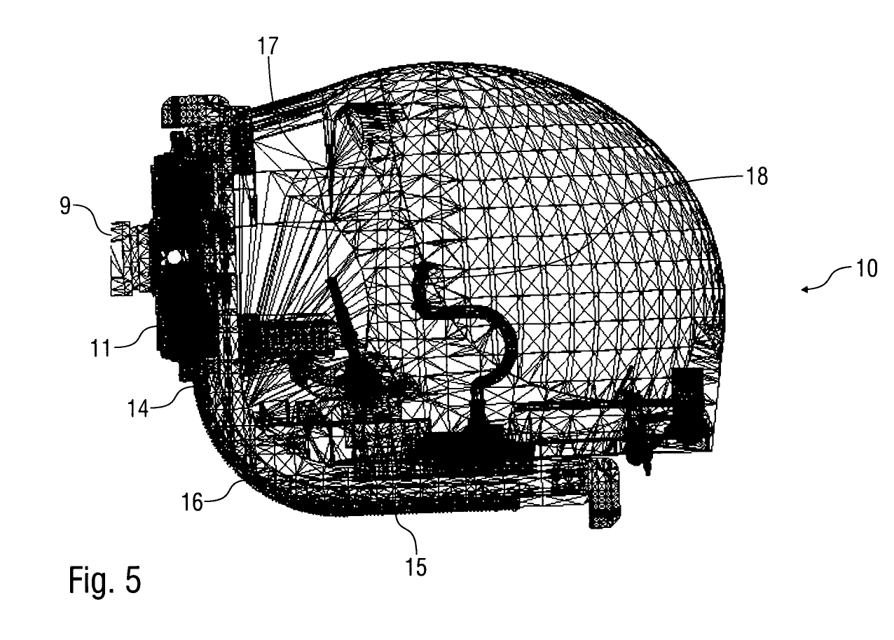

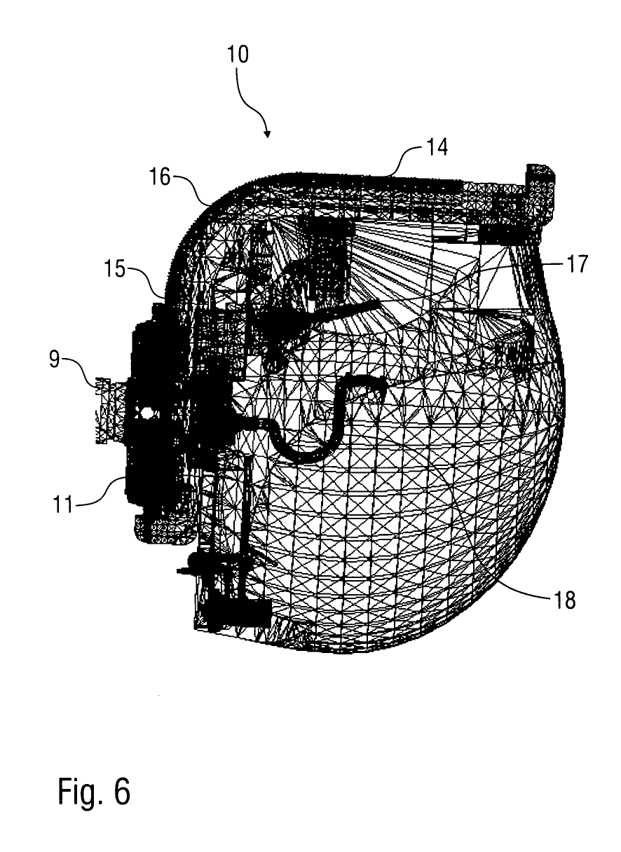

The hand wrist 8 comprises a mounting flange 9 to which a cabin arrangement 10 (cf. FIGS. 5 and 6) is mounted via an additional seat axis.

The seat axis essentially consists of a carriage 11 attached to the mounting flange 9 of the hand wrist 8 and a curved guide rail 12 fixedly attached to a cabin 13 of the cabin arrangement 10.

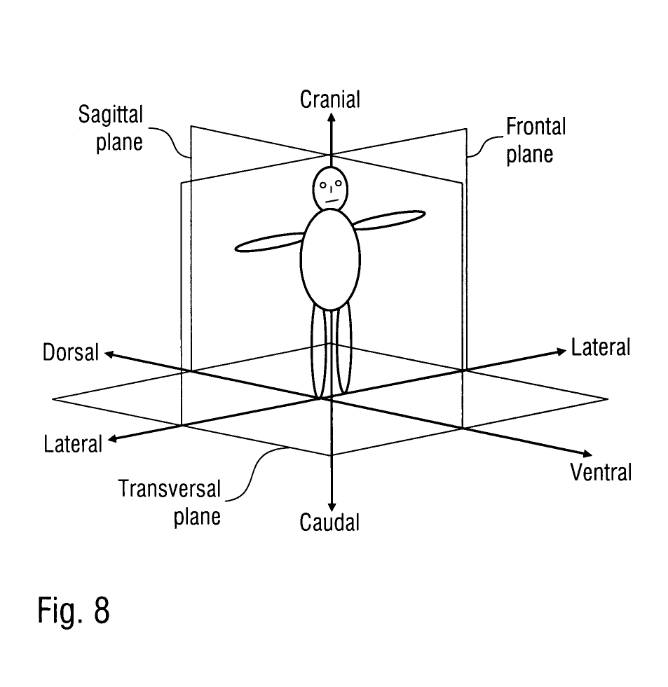

The guide rail 12 is substantially L-shaped and comprises two arms 14, 15, wherein the arms 14, 15 are orthogonally aligned and connected by a curved section 16 of the guide rail 12. The guide rail 12 can be moved linearly relative to the carriage 11 thereby tilting the entire cabin arrangement 10 in a sagittal plane (cf. FIG. 8).

Further, it should be noted that the cabin arrangement 10 comprises a seat 17 for the operator and a control stick 18, wherein both the seat 17 and the control stick 18 are arranged inside the cabin 13.

Moreover, the cabin arrangement 10 comprises a stereoscopic display inside the cabin 13 so that the operator perceives a stereoscopic image of the simulated environment thereby improving the realistic awareness of the simulation.

FIG. 1 shows a first orientation of the cabin arrangement 10 which is aligned horizontally. Further, the robot link 5 is rotated around the axis of rotation A around the robot base 2, so that the operator in the seat 17 of the cabin 13 arrangement 10 perceives a centrifugal force which is ventrally aligned (cf. FIG. 8).

FIG. 2 shows an alternative orientation of the cabin arrangement 10, which is also horizontally aligned. However, the distance between the seat 17 for the operator and the axis of rotation A is almost zero, so that the cabin arrangement 10 can be re-orientated without causing any substantial centrifugal forces.

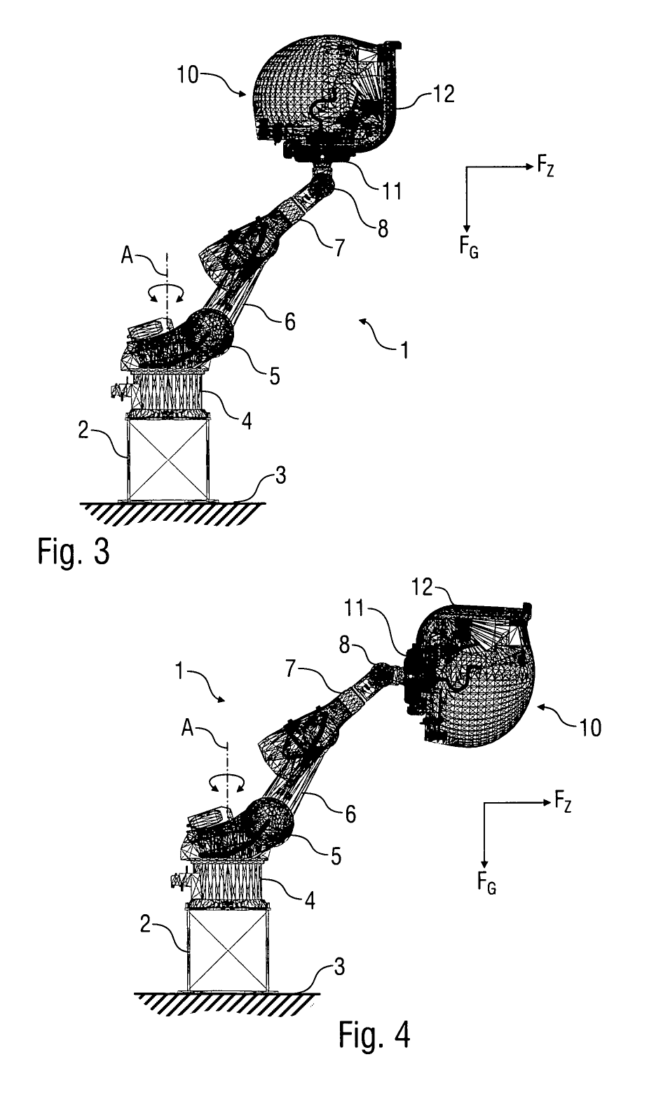

FIG. 3 shows a different orientation of the cabin arrangement 10, in which the operator in the seat 17 faces the axis of rotation A. Therefore, the operator in the seat 17 perceives the centrifugal forces as a dorsally directed force (cf. FIG. 8).

It should be noted that the orientation of the cabin arrangement 10 as shown in FIG. 3 would not be possible without the additional seat axis consisting of the carriage 11 and the guide rail 12. Further, the seat axis allows a simulation of a forwards acceleration by continuously rotating the cabin arrangement 10 around the axis of rotation A.

A comparison of FIGS. 1 and 4 illustrates the movement which is realized by a gliding movement of the carriage 11 relative to the curved guide rail 12. The displacement of the contact point between the guide rail 12 and the carriage 11 is necessary to achieve the orientation of the cabin arrangement 10 as shown in FIG. 3.

Moreover, FIG. 4 shows another orientation of the cabin arrangement 10, wherein the cabin arrangement 10 is tilted forwards by an angle of 90°, so that the operator in the seat 17 looks downwards to the foundation 3. Therefore, the operator in the seat 17 perceives the centrifugal force generated by the rotation of the multi-axis serial robot 1 as a cranially directed force (cf. FIG. 8).

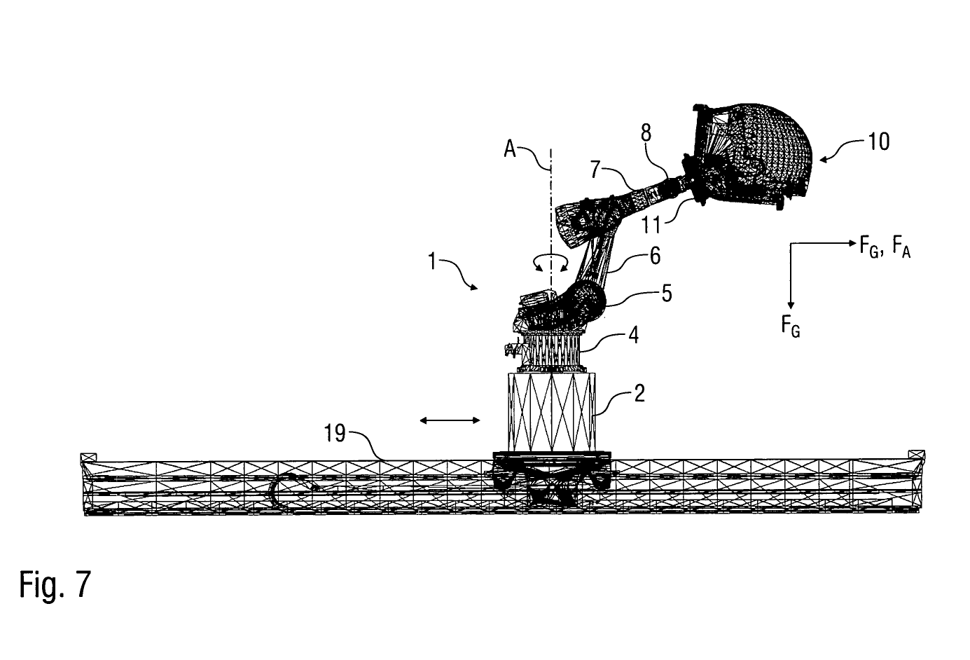

FIG. 7 illustrates an alternative embodiment of the invention which corresponds to the embodiment according to FIGS. 1-6 to a large extent. Therefore, reference is made to the above description and the same reference numerals are used for corresponding parts and details.

One characteristic of this embodiment is that the motion simulator additionally comprises a linear axis 19, wherein the robot base 2 is mounted on the linear axis 19, so that the multi-axis serial robot 1 can be moved along the linear axis 19 in the direction of the arrows.

Therefore, the linear axis 19 expands the work space of the motion simulator thereby improving the realistic awareness of the simulation.

Although the invention has been described with reference to the particular arrangement of parts, features and the like, these are not intended to exhaust all possible arrangements of features, and indeed many other modifications and variations will be ascertainable to those skilled in the art.

### LIST OF REFERENCE NUMERALS

1 Multi-axis serial robot
2 Robot base
3 Foundation
4 Base axis
5 Robot link
6 Robot arm
7 Robot arm
8 Hand wrist
9 Mounting flange of the hand wrist
10 Cabin arrangement
11 Carriage
12 Guide rail
13 Cabin
14 Arm of the guide rail
15 Arm of the guide rail
16 Curved section of the guide rail
17 Seat
18 Control stick
19 Linear axis
A Axis of rotation

1-15. (canceled)

16. A motion simulator for simulating a motion of a vehicle, comprising:
a) a multi-axis serial robot comprising a rotatable base axis, and
b) a seat for an operator, wherein the seat is attached to the multi-axis serial robot, so that the seat can be moved in space by the multi-axis serial robot for simulation of a real movement,
wherein the motion simulator is adapted to simulate a long-lasting acceleration or deceleration by generating a centrifugal force acting on the operator.

17. The motion simulator according to claim 16, wherein the rotatable base axis of the multi-axis serial robot is indefinitely rotatable in order to simulate an acceleration by generating a centrifugal force caused by a rotation of the seat around the base axis of the multi-axis serial robot.

18. The motion simulator according to claim 17, wherein the rotatable base axis comprises a slip ring making an electrical connection between rotatable parts of the rotatable axis.

19. The motion simulator according to claim 16, further comprising a linear axis wherein the multi-axis serial robot is movable along the linear axis, so that a work space of the multi-axis serial robot is expanded thereby making the simulation more realistic.

20. The motion simulator according to claim 19, wherein the linear axis allows a linear movement of the multi-axis serial robot of more than 4 m.

21. The motion simulator according to claim 16, wherein the seat is attached to a tool center point of the multi-axis serial robot by an additional seat axis, wherein the seat axis allows a movement of the seat relative to the tool center point of the multi-axis serial robot.

22. The motion simulator according to claim 21, wherein the seat axis allows at least a rotation of the seat in a sagittal plane of the operator in the seat.

23. The motion simulator according to claim 22, wherein the seat axis allows a rotary movement of at least 90° in the sagittal plane of the operator in the seat.

24. The motion simulator according to claim 21, wherein the seat axis allows at least a rotation of the seat in a transversal plane of the operator in the seat.

25. The motion simulator according to claim 21, wherein the seat axis allows at least a rotation of the seat in the frontal plane of the operator in the seat.

26. The motion simulator according to claim 21, wherein the rotation of the seat is made by the seat axis alone or by the seat axis in combination with other axes of the multi-axis serial robot.

27. The motion simulator according to claim 21, wherein
a) the seat can by aligned such that the centrifugal force caused by the rotation of the multi-axis serial robot around the base axis is cranially directed with regard to the operator, and
b) the seat can by aligned such that the centrifugal force caused by the rotation of the multi-axis serial robot around the base axis is caudally directed with regard to the operator, and
c) the seat can by aligned such that the centrifugal force caused by the rotation of the multi-axis serial robot around the base axis is ventrally directed with regard to the operator, and
d) the seat can by aligned such that the centrifugal force caused by the rotation of the multi-axis serial robot around the base axis is dorsally directed with regard to the operator, and
e) the seat can by aligned such that the centrifugal force caused by the rotation of the multi-axis serial robot around the base axis is laterally directed with regard to the operator.

28. The motion simulator according to claim 21, wherein the seat axis comprises a curved guide rail and a carriage which is movable along the guide rail.

29. The motion simulator according to claim 28, wherein the carriage is attached to a tool center point of the multi-axis serial robot and the guide rail is attached to the seat, so that the seat is movable relative to the tool center point of the multi-axis serial robot.

30. The motion simulator according to claim 29, wherein the guide rail is substantially L-shaped, C-shaped, circular, elliptical or O-shaped.

31. The motion simulator according to claim 29, wherein the guide rail along with the seat is rotatable around a vertical axis.

32. The motion simulator according to claim 30, wherein
a) the seat is arranged in a cabin, and
b) the cabin is closed so that the operator does not perceive any tilt of the cabin relative to the real world, and
c) the cabin comprises at least one visual display, and
d) the cabin resembles a cabin or cockpit of the vehicle to be simulated.

33. The motion simulator according to claim 30, further comprising a hardware limit stop limiting a motion space of the multi-axis serial robot to avoid a collision.

34. The motion simulator according to claim 30, further comprising a software limit stop limiting a motion space of the multi-axis serial robot to avoid a collision.

35. The motion simulator according to claim 30, further comprising a multi-step safety arrangement comprising software end stops in an operating program, software end stops in a robot controller and hardware end stops in the multi-axis serial robot.

36. The motion simulator according to claim 30, wherein the base axis is rotatable around a vertical axis.

37. A method for simulating a motion of a vehicle by use of a multi-axis serial robot carrying a seat, comprising the following steps:
a) placing an operator in the seat, and
b) moving the seat along with the operator in space to simulate a real movement of the operator,
wherein long-lasting accelerations or decelerations are simulated by generating a centrifugal force acting on the operator.

38. The method according to claim 37, wherein the rotatable base axis is rotated by more than 2 revolutions to simulate a correspondingly long-lasting acceleration or deceleration.

39. The method according to claim 37, further comprising the step of moving the multi-axis serial robot along at least one linear axis to expand the work space of the multi-axis serial robot thereby making the simulation more realistic.

40. The method according to claim 37, further comprising the following steps:
a) aligning the seat with a back rest thereof towards the rotation axis of the rotatable base axis in order to simulate a ventrally directed deceleration or a dorsally directed acceleration, and
b) aligning the seat with a front side thereof towards the rotation axis of the rotatable base axis in order to simulate a ventrally directed acceleration or a dorsally directed deceleration, and
c) aligning the seat with a seating area thereof towards the rotation axis of the rotatable base axis in order to simulate a cranially directed acceleration or a caudally directed deceleration, and
d) aligning the seat with an upper side thereof towards the rotation axis of the rotatable base axis in order to simulate a caudally directed acceleration or a cranially directed deceleration.
